(19) United States
(12) Patent Application Publication
(10) Pub. No.: US 2006/0268361 A1
(43) Pub. Date: Nov. 30, 2006

(54) Reproduction equipment-associated user interface for enabling two-sided identification document copying

(75) Inventor: Marc J. Krolczyk, Spencerport, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 11/131,519

(22) Filed: May 18, 2005

(51) Int. Cl. H04N 1/387

(52) U.S. Cl. 358/450; 358/474; 358/486

(57) ABSTRACT

An ID Card copy service (ID Copy) enables a photocopier system user to scan and render the front and back of an ID onto a single side of a sheet of paper. The service can place and center both sides of an ID onto a single page template that is rendered. A photocopier system adapted for ID Copy services includes an ID copying software module; a user interface combining standard copy features with an ID copy service; memory adapted for storing images of front and back sides of IDs captured by the photocopier following selection of the ID service feature; a microprocessor adapted by the ID copying software to enable user selection of the ID copy service feature using the user interface, user scanning of images of both sides of an ID, and photocopier rendering of the images on one side of a single sheet of paper.

### TECHNICAL FIELD

The present embodiments relate of methods for duplicating identification documents using photocopier equipment. More particularly, the embodiments relate to user interface adaptation of photocopier equipment for enabling double-sided reproduction of identification documents.

### BACKGROUND

Identification documents (hereafter also referred to as “ID Cards”) play a critical role in today's society. Identification documents are used on a daily basis—to prove identity, to verify age, to access a secure area, to evidence driving privileges, to cash a check, and so on. Airplane passengers are required to show an identification document during check in, security screening, and prior to boarding their flight. In addition, because we live in an ever-evolving cashless society, ID Cards are used to make payments, access an ATM, debit an account, or make a payment, etc. Identification documents, such as ID Cards, having printed background security patterns, designs or logos and identification data personal to the card bearer have been known and are well documented. Laminated identification documents are typically used as certificates of citizenship, identification cards, driver's licenses, member cards, passports, transaction cards, national identification cards, etc.

Many types of identification documents and ID cards, such as driving licenses, national or government identification cards, bank cards, credit cards, controlled access cards and smart cards, carry thereon certain items of information which relate to the identity of the bearer. Examples of such information include names, addresses, birth dates, signatures and photographic images; the cards or documents may additionally carry other variant data (i.e., data specific to a particular card or document, for example an employee number) and invariant data (i.e., data common to a large number of cards, for example the name of an employer).

For the purposes of this disclosure, “ID Cards” are broadly defined herein, and include, e.g., credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc. Also, the terms “document,” “card,” “badge” and “documentation” are meant to be used interchangeably throughout this description.

As those skilled in the art know, ID Cards such as drivers licenses can contain information on both sides of the document such as a photographic image, a bar code (which may contain information specific to the person whose image appears in the photographic image, and/or information that is the same from ID Card to ID Card), variable personal information, such as an address, signature, and/or birth dates, and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

In the production of images useful in the field of identification documentation, it is oftentimes desirable to embody onto a single sided page of a document a copy of both sides of an ID Card (such as a driver's license, passport or the like). Typically, only one side of an identification document can be imaged at a time after placement on a photocopier machine's glass platen, although both sides of the identification document are what is desired. If both sides of an identification document are to be shown on a single side of a paper, the photocopier user can request a 2-up operation, in which case the document is first image at the platen and then flipped for imaging once again. Prior to 2-up operation, a user could take a first copy of an identification document, flip the identification over and place the rendered copy of the first side of the identification document on the platen over the flipped identification document. The user, however, must take special care as to where on the platen the identification document is placed during imaging a second time so that it does not interfere with the first image.

There is thus a need to simplify reproduction of both sides of an identification document using photocopier equipment. The present embodiments address the need to simplify two-sided identification document reproduction.

### SUMMARY

An ID Card copy service (ID Copy) enables a photocopier system user to scan and render the front and back of an ID onto a single side of a sheet of paper. The service can place and center both sides of an ID onto a single page template that is rendered. A photocopier system adapted for ID Copy services includes an ID copying software module; a user interface combining standard copy features with an ID copy service; memory adapted for storing images of front and back sides of IDs captured by the photocopier following selection of the ID service feature; a microprocessor adapted by the ID copying software to enable user selection of the ID copy service feature using the user interface, user scanning of images of both sides of an ID, and photocopier rendering of the images on one side of a single sheet of paper.

It is a feature of the embodiment to presenting a ID card copying feature into a simplified/specialized UI will enhance usability and find-ability. The ID card copying service enabled through screen shots via a user interface enables a user to copy both the front and back of an ID onto a single side of a full size sheet of paper.

It is another feature of the embodiment to provide a user interface wherein Tab 1 of the ID Card Copy service is presented and wherein the user selects from a very limited set of copy features on the main tab including: Color, R/E, Paper Supply and the number of sides to be imaged.

It is another feature of the embodiment to provide a user interface wherein Tab 2 of the ID Card Copy service covers any limited set of image quality settings, e.g., Lighten-Darken, etc.

It is a feature of the embodiment to provide a method for scanning both sides of an identification card and render images of both sides of the identification card on a single sheet of paper that enables a user desiring two-sided ID Card copy output to select an ID card Copy service from a user interface associated with a photocopier; and enter the ID Card copy services screen; enables the user to view and select copying features at an ID Card Copy services screen on the user interface, said features including at least one of output color, reduce, enlarge, and paper supply selection; and enables the user to approve selections and activate the photocopier system to enable the user to scan both sides of an identification card and render images of both sides on a single sheet of paper.

### BRIEF DESCRIPTION OF THE DRAWINGS

FIG. 1 is a high level illustration of a process in accordance with an embodiment wherein both sides of an identification document (e.g., ID card) copied on a single side of a sheet of paper.

FIG. 2 illustrates a photocopier system wherein the ID Card Copy service and module in accordance with an embodiment can operate.

FIG. 3 illustrates a user interface provided as an all services screen wherein ID Card Copy is illustrated as a service feature selected by the user.

FIG. 4 illustrates a user interface wherein Tab 1 of the ID Card Copy service is presented and wherein the user selects from a very limited set of copy features on the main tab including: Color, R/E, Paper Supply and original sides imaged.

FIG. 5 illustrates a user interface wherein Tab 2 of the ID Card Copy service covers any limited set of image quality settings, e.g., Lighten-Darken, etc.

FIG. 6 illustrates a flow diagram of one method for executing the ID Card Copy service process.

### DETAILED DESCRIPTION OF THE EMBODIMENTS

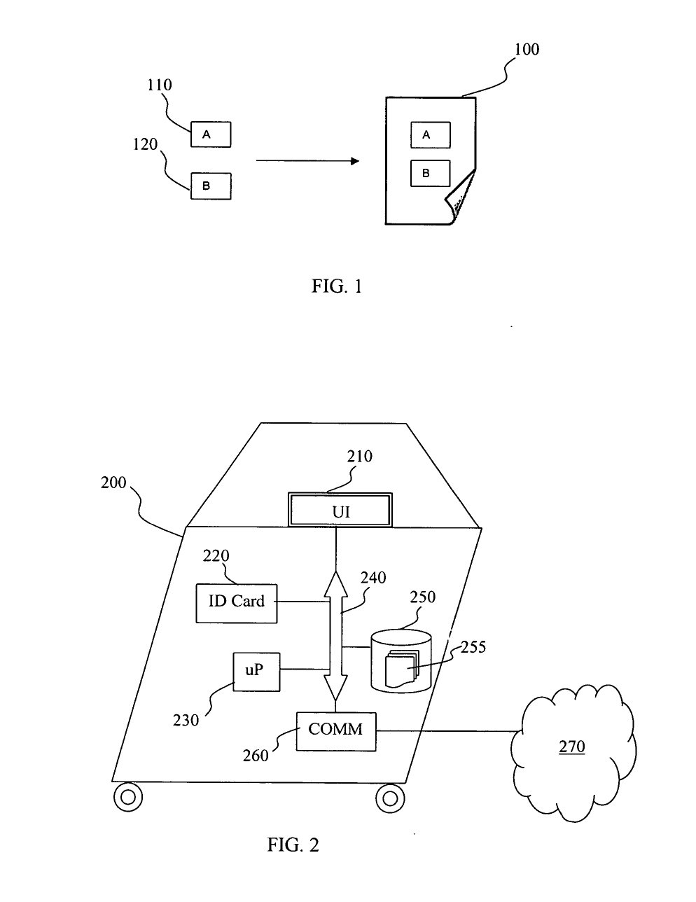

Referring to FIG. 1, a high level illustration of a process in accordance with the embodiment is shown. An ID card has photographs and/or writing on both of its sides, Side A 110 and Side B 120. The ID copy service of the present embodiment enables to photocopying of Side A 110 and Side B 120 and renders the photocopies on a single sheet of paper 100. As shown in FIG. 1, Side A is placed on the paper 100 above Side B, and both images are centered.

FIG. 2 illustrates a photocopier system 200 wherein the ID Card Copy service module 220 can operate. The photocopier typically has a user interface 210, microprocessor 230, memory 250 and internal communications bus 240. Networked photocopiers also have communications hardware 260 with an operation connection to a network 270. The photocopier 200 is adapted with such a configuration to photocopy front and back sides of an ID card. The user interface (UI) 210 combines standard copy features and includes an “ID card copy service”. The memory 250 is adapted for storing the images of front and back sides of ID cards captured by the photocopier 200 following selection of the ID card-specific job build selection feature on the UI 210. The microprocessor 230 together with the ID card copying software 220 enables the UI 210 and photocopier 200 to capture images of both sides of an ID card and render both images on a single sheet of paper as shown with the process in FIG. 1.

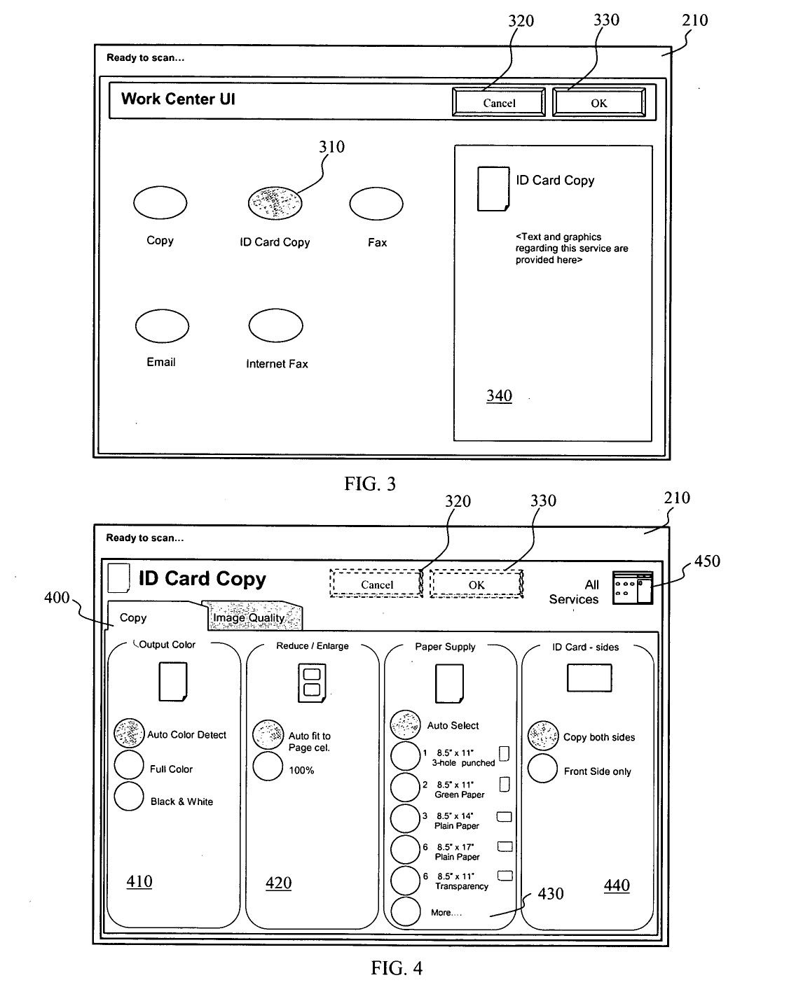

Referring to FIG. 3, illustrated is a user interface (UI) 210 in accordance with the embodiments. The Work Center UI 210 includes an ID Card copy service 310 selection in the form of a soft-button that is accessible via a touch screen common to modern photocopier systems. When a copy feature is selected, a description of the features is provided in a text box 340. In the UI 210 shown in FIG. 3, the text box will identify the type of service selected (e.g. ID Card Copy) and provide a description and instructions about the feature. Also provided on the UI 210 are a cancel 320 and OK 330 soft buttons. The user can cancel the Work Center UI 320 or accept the selection 330 using these soft buttons.

Referring to FIG. 4, once the ID Card Copy service 310 is selected at the Work Center UI, the user is provided with specific functions associated with the features. As shown on the UI 210 in FIG. 4, the user can selected the TAB 1 “Copy” 400 tab and selected the output color 410, reduction enlargement 420, paper supply type 430 and the number of sides 440 that will be copied from an ID Card. The user makes the selections (shown grey in the FIG. 4) and proceeds with scanning an ID Card. Optionally, the UI 210 can also provide OK 330 and Cancel 320 soft buttons in the UI; although a hard button is usually provided on most photocopiers to enable a user to start a photocopying job. By selecting the “all services” button 450, a user can also return to an “all services” (or home) screen for the photocopier system.

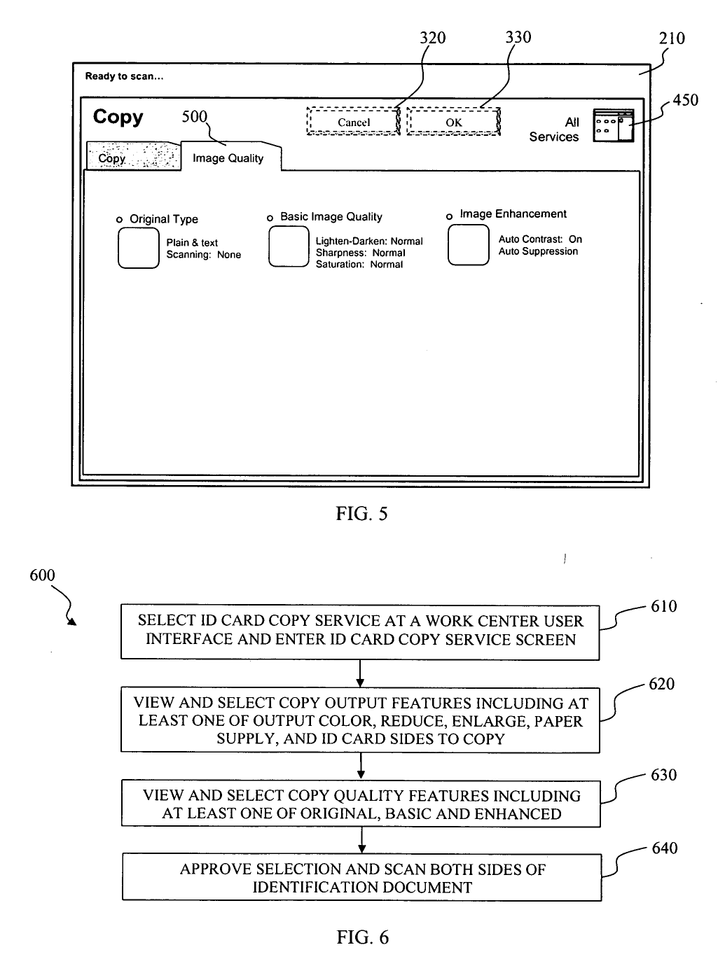

Referring to FIG. 5, illustrated is information provided on TAB 2 “Image Quality” 500 associated with the ID Card Service on the UI 210. From TAB 2, the user can select from “original”, “basic” or “enhanced” quality features prior to scanning an ID card. As with FIG. 4, the user can also cancel 320, OK 330 or return home to “all Services 450 from the UI 210.

Referring to FIG. 6, a flow diagram 600 of an ID card copying process in accordance with the embodiment is illustrated. As shown in block 610, a user selects ID card Copy service at a work center user interface associated with a photocopier and enter the ID Card copy services screen. As shown in block 620, the user can view and select, at the ID Card Copy services screen on a UI, features for the user's copy output, including at least one of output color, reduce, enlarge, paper supply selection, and identify if one or two sides of an ID card are to be copied. As shown in block 630, the user can view and select, from the UI, copy quality features including at least one of original, basic and enhanced features. As shown in Block 640, the user can approve selections, which will enable the user to use the photocopier system to scan both sides of an identification card and render the copies of both sides on a single sheet of paper.

Two-sided identification document duplication system and method are enabled through a photocopier system including a user interface (UI), software and associated print drivers. A specialized UI as described herein enhances usability and find-ability of two-sided ID Card duplication services. The service allows a user to copy both the front and back of an ID onto a single side of a full size sheet of paper. The service places and centers both sides of an ID card onto a single page template that is rendered.

1. A photocopier system adapted to scan front and back sides of an ID card and render images of the front and back sides of an ID card on one side of a sheet of paper, comprising:
a photocopier including an ID card copying software module;
a user interface combining standard copy features with an ID card copy service;
memory adapted for storing images of front and back sides of ID cards captured by the photocopier following selection of the ID card service feature;
a microprocessor adapted by the ID card copying software to enable user selection of the ID card copy service feature using the user interface, user scanning of images of both sides of an ID card, and photocopier rendering of the images on one side of a single sheet of paper.

2. The system of claim 1, wherein said UI further comprises a Tab 1 with the ID Card Copy service wherein a user can select at least one of: color and paper supply.

3. The system of claim 3, wherein said UI further comprises a Tab 2 with the ID Card Copy service enabling user selection of image quality settings including at least one of: Lighten, Darken, and contrast.

4. The system of claim 1, wherein said UI further comprises a Tab 2 with the ID Card Copy service enabling user selection of image quality settings including at least one of: Lighten, Darken, and contrast.

5. The system of claim 4, wherein said UI further comprises a Tab 1 with the ID Card Copy service wherein a user can select at least one of: color and paper supply.

6. The system of claim 1, further comprising communication hardware and a network connection.

7. The system of claim 6, wherein the user interface further comprises a Tab 1 with the ID Card Copy service wherein a user can select at least one of: color and paper supply.

8. The system of claim 7, wherein the user interface further comprises a Tab 2 with the ID Card Copy service enabling user selection of image quality settings including at least one of: Lighten, Darken, and contrast.

9. The system of claim 6, wherein the user interface further comprises a Tab 2 with the ID Card Copy service enabling user selection of image quality settings including at least one of: Lighten, Darken, and contrast.

10. The system of claim 9, wherein the user interface further comprises a Tab 1 with the ID Card Copy service wherein a user can select at least one of: color and paper supply.

11. Method for scanning both sides of an identification card and render images of both sides of the identification card on a single sheet of paper, said method comprising the steps of:
enabling a user desiring two-sided ID Card copy output to select an ID card Copy service from a user interface associated with a photocopier; and enter the ID Card copy services screen;
enabling the user to view and select copying features at an ID Card Copy services screen on the user interface, said features including at least one of output color, reduce, enlarge, and paper supply selection; and
enabling the user to approve selections and activate the photocopier system to enable the user to scan both sides of an identification card and render images of both sides on a single sheet of paper.

12. The method of claim 11, further comprising the step of enabling the user to view and select, from the user interface, copy quality features including at least one of: original, basic and enhanced, prior to said step of enabling the user to approve selection and activate the photocopier system.

13. Method for scanning both sides of an identification card and render images of both sides of the identification card on a single sheet of paper, said method comprising the steps of:
enabling a user desiring two-sided ID Card copy output to select an ID card Copy service from a user interface associated with a photocopier; and enter the ID Card copy services screen;
enabling the user to view and select copying features at an ID Card Copy services screen on the user interface, said features including at least one of output color, reduce, enlarge, and paper supply selection;
enabling the user to view and select copy quality features at the user interface, including at least one of: original, basic and enhanced; and
enabling the user to approve selections and activate the photocopier system to enable the user to scan both sides of an identification card and render images of both sides on a single sheet of paper.
